(19) United States
(12) Patent Application Publication
(10) Pub. No.: US 2025/0362960 A1
(43) Pub. Date: Nov. 27, 2025

(54) RESOURCE ALLOCATION METHOD AND APPARATUS, AND COMPUTER PROGRAM

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventor: Shinsuke KURODA, Osaka-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 18/873,046

(22) PCT Filed: May 8, 2023
(86) PCT No.: PCT/JP2023/017226

§ 371 Date: Dec. 9, 2024

(30) Foreign Application Priority Data
Jun. 9, 2022 (JP) 2022-093583

(51) Int. Cl. G06F 9/50; H04W 4/44

(52) U.S. Cl. CPC G06F 9/5027; G06F 9/5083; H04W 4/44

(57) ABSTRACT

A resource allocation method that is capable of being used in an in-vehicle device that provides driving assistance functions by communicating with a server, the resource allocation method including: executing allocation processing to allocate, to each function of the in-vehicle device, resources of the server being the service providing device covering the traveling area of the relevant vehicle and resources of the relevant vehicle, with use of a processor; and re-executing the allocation processing in response to detecting or predicting a change in a number of vehicles that are present within the traveling area and that cooperate with the server, with use of the processor.

### BACKGROUND

The present disclosure relates to a resource allocation method and apparatus, and a computer program. This application claims priority based on Japanese Application No. 2022-093583, filed Jun. 9, 2022, and incorporates all the contents described in the Japanese application.

For an in-vehicle device having driving assistance functions, computing resources available to the device may change. For example, if some devices in the vehicle fail, the functions that they have been responsible for will no longer be available to the in-vehicle device. In such cases, other computing resources will need to be allocated to the lost functions. The following JP 2021-93090A discloses a technology for reallocating computing resources in such cases.

### SUMMARY

A resource allocation method according to a first aspect of the present disclosure is a resource allocation method that is capable of being used in an in-vehicle device that provides driving assistance functions by communicating with a server. The in-vehicle device is a switching in-vehicle device that allocates resources to each function of the in-vehicle device while switching between resources of a service providing device covering a traveling area of a vehicle equipped with the in-vehicle device and resources of a relevant vehicle being the vehicle equipped with the in-vehicle device. The resource allocation method includes: executing allocation processing to allocate, to each function of the in-vehicle device, resources of the server being the service providing device covering the traveling area of the relevant vehicle and resources of the relevant vehicle, with use of a processor; and re-executing the allocation processing in response to detecting or predicting a change in a number of vehicles that are present within the traveling area and that cooperate with the server, with use of the processor.

A resource allocation apparatus according to a second aspect of the present disclosure is a resource allocation apparatus that is configured to be used in an in-vehicle device that provides driving assistance functions by communicating with a server. The in-vehicle device is a switching in-vehicle device that allocates resources to each function of the in-vehicle device while switching between resources of a server covering a traveling area of a vehicle equipped with the in-vehicle device and resources of a relevant vehicle being the vehicle equipped with the in-vehicle device. The resource allocation apparatus includes: executing processor that is configured to execute allocation processing to allocate, to each function of the in-vehicle device, resources of the server covering the traveling area of the relevant vehicle and resources of the relevant vehicle; and re-execute the allocation processing in response to detecting or predicting a change in the number of vehicles that are present in the traveling area and that cooperate with the server.

A storage medium that stores a computer program according to a third aspect of the present disclosure is a storage medium that stores a computer program that causes a processor to allocate resources in an in-vehicle device that provides driving assistance functions by communicating with a server. The in-vehicle device is a switching in-vehicle device that allocates resources to each function of the in-vehicle device while switching between resources of a server covering a traveling area of a vehicle equipped with the in-vehicle device and resources of a relevant vehicle being the vehicle equipped with the in-vehicle device. The computer program causes the processor to execute allocation processing to allocate, to each function of the in-vehicle device, resources of the server covering the traveling area of the relevant vehicle and resources of the relevant vehicle; and re-execute the allocation processing in response to detecting or predicting a change in the number of vehicles that are present in the traveling area and that cooperate with the server.

The above and other objects, features, aspects, and advantages of this invention will become apparent from the following detailed description of the invention, which will be understood in conjunction with the accompanying drawings.

### BRIEF DESCRIPTION OF THE DRAWINGS

FIG. 1 is a diagram showing the technological development stages of in-vehicle edge servers.

FIG. 2 is a block diagram showing a schematic configuration of a vehicle system participating in a cooperative system according to a first embodiment of the present disclosure.

FIG. 3 shows one example of the cooperative system according to the first embodiment.

FIG. 4 is a hardware block diagram of a computer that realizes an in-vehicle edge server of the vehicle system shown in FIG. 2.

FIG. 5 is a block diagram showing a functional configuration of the in-vehicle edge server shown in FIG. 4.

FIG. 6 shows types of server configurations and characteristics thereof in tabular form.

FIG. 7 shows, in tabular form, switching patterns of cooperation between the in-vehicle edge server and servers in accordance with combination of the type of vehicle present around a relevant vehicle, a change in vehicle movement, and server resource status.

FIG. 8 is a flowchart illustrating a schematic configuration of a program executed by the in-vehicle edge server.

FIG. 9 is a flowchart illustrating a control structure of a program that reallocates resource in the in-vehicle edge server of a switching type in which resources can be switched between those of the relevant vehicle and the servers.

FIG. 10 is a flowchart illustrating the first half of a control structure of a program executed when a switching-type nearby vehicle is present in the flowchart shown in FIG. 9.

FIG. 11 is a flowchart illustrating the second half of the control structure of the program executed when a switching type nearby vehicle is present in the flowchart shown in FIG. 9.

FIG. 12 is a flowchart illustrating the first half of the control structure of a program executed when no switching-type nearby vehicle is present in the flowchart shown in FIG. 9.

FIG. 13 is a flowchart illustrating the second half of the control structure of the program executed when no switching-type nearby vehicle is present in the flowchart shown in FIG. 9.

FIG. 14 shows, in a tabular form, resource allocation between real-time applications and non-real-time applications in a switching-type vehicle with respect to the server configuration of a switching destination.

FIG. 15 is a flowchart illustrating a control structure of a program for switching, in an in-vehicle device of the switching type, resources for a certain function from those of the relevant vehicle to those of the servers.

FIG. 16 shows, in tabular form, server resource status and resource allocation to the real-time applications and the non-real-time applications for resource coordination with nearby vehicles.

FIG. 17 is a flowchart illustrating a control structure of a program for resource coordination with a switching-type nearby vehicle.

FIG. 18 is a flowchart illustrating a control structure of a program for switching resources using an edge server.

FIG. 19 is a flowchart illustrating a control structure of a program for priority processing performed with a switching-type nearby vehicle with respect to the real-time applications.

FIG. 20 is a flowchart illustrating a control structure of a program for priority processing performed with a switching-type nearby vehicle with respect to the non-real-time applications.

FIG. 21 is a flowchart illustrating a control structure of a program for switching resources without using the edge server.

### DETAILED DESCRIPTION OF EMBODIMENTS

### Problem to be Solved by the Present Disclosure

According to the technology disclosed in JP 2021-93090A, it is possible to obtain an effect that computing resources of a type different from computing resources no longer available to the in-vehicle device can be allocated to functions of the in-vehicle device.

However, it is predicted that the spread of the in-vehicle devices having driving assistance functions will accelerate in the future. Meanwhile, the functions required of the in-vehicle devices are also expected to diversify. For example, it is also conceivable that functions may emerge that cannot be realized by computing resources available to the in-vehicle devices due to limitations of vehicle hardware. The technology of JP 2021-93090A is unable to adequately address this issue.

Therefore, the present disclosure aims to provide a resource allocation method and apparatus and a computer program that can flexibly provide various functions.

### Effects of the Present Disclosure

As described above, according to the present disclosure, it is possible to provide a resource allocation method and apparatus and a computer program that can flexibly provide various functions.

### Description of Embodiments of the Present Disclosure

In the following description and the drawings, the same parts are assigned the same reference numbers. Accordingly, the detailed description of those parts is not repeated. Note that one or more of the following features may be combined.

(1) A resource allocation method according to the first aspect of the present disclosure is a resource allocation method for use in an in-vehicle device that provides driving assistance functions by communicating with a server. The in-vehicle device is a switching-type in-vehicle device that allocates resources to each function of the in-vehicle device while switching between resources of a service providing device covering a traveling area of a vehicle equipped with the in-vehicle device and resources of a relevant vehicle being the vehicle equipped with the in-vehicle device. The resource allocation method includes: a step of executing allocation processing to allocate, to each function of the in-vehicle device, resources of a server being the service providing device covering the traveling area of the relevant vehicle and resources of the relevant vehicle, with use of a computer; and a step of re-executing the allocation processing in response to detecting or predicting a change in the number of vehicles that are present within the traveling area and that cooperate with the server, with use of the computer.

With this configuration, resources of the server and the vehicle can be flexibly allocated as resources for realizing each function in accordance with changes in the number of vehicles that are present within the traveling area and cooperate with the server. As a result, various functions for the vehicle can be provided flexibly.

(2) In the above item (1), the re-executing step may include: a step of judging whether each vehicle present within a nearby area including the traveling area and an adjacent area being an area adjacent to the traveling area is an independent-type vehicle that does not cooperate with the service providing device, a cooperative-type vehicle that cooperates with the service providing device using fixed resource allocation, or a switching-type vehicle equipped with the switching type in-vehicle device, with use of the computer; a first determination step of determining whether or not a vehicle other than the independent-type vehicle is present within the nearby area, with use of the computer; and a step of executing processing to reallocate, to each function of the in-vehicle device, resources of the relevant vehicle and resources of the server in accordance with available resources of the server, in response to determining in the first determination step that a vehicle other than the independent-type vehicle is present within the nearby area, with use of the computer.

With this configuration, resources of the server and the vehicle can be flexibly allocated as resources for realizing each function in accordance with the number of vehicles that cooperate with the server, regardless of the number of independent-type vehicles present within the nearby area. As a result, various functions for the vehicle can be provided flexibly.

(3) In the above item (2), the step of executing processing to reallocate resources may include: a second determination step of determining whether or not the switching-type vehicle other than the relevant vehicle is present within the nearby area, with use of the computer; a first reallocation execution step of executing processing to reallocate, to each function of the in-vehicle device, resources of the server and resources of the relevant vehicle based on a result of coordination regarding resources of the server with the switching-type vehicle present within the nearby area and a status of available resources of the server, in response to a result of the determination in the second determination step indicating that the switching-type vehicle other than the relevant vehicle is present within the nearby area, with use of the computer; and a second reallocation execution step of executing processing to reallocate, to each function of the in-vehicle device, resources of the server and resources of the relevant vehicle based on the status of available resources of the server, in response to the result of the determination in the second determination step indicating that the switching-type vehicle other than the relevant vehicle is not present within the nearby area, with use of the computer.

With this configuration, resources of the server and the relevant vehicle can be flexibly allocated as resources for realizing each function in accordance with the number of switching-type nearby vehicles, regardless of the number of independent-type vehicles and cooperative-type vehicles that are present within the traveling area. As a result, various functions for the vehicle can be provided flexibly.

(4) In the above item (3), the first reallocation execution step may include: a first detection step of detecting or predicting an increase in the number of cooperative-type vehicles or the number of switching-type vehicles present within the traveling area, in response to the result of the determination in the second determination step indicating that the switching-type vehicle other than the relevant vehicle is present within the nearby area, with use of the computer; a third determination step of determining whether or not resources of the server are to become insufficient, in response to detecting or predicting an increase in the number of cooperative-type vehicles or the number of switching-type vehicles present within the traveling area in the first detection step, with use of the computer; and a step of, in response to a result of the determination in the third determination step indicating that resources of the server are to become insufficient, executing coordination regarding resources of the server with the switching-type vehicle present within the nearby area, and switching at least some of the resources of the server that have been allocated to functions of the in-vehicle device to resources of the relevant vehicle based on a result of the coordination, with use of the computer.

With this configuration, it is possible to coordinate resources of the server that are predicted to decrease between the vehicles and allocate resources of the relevant vehicle to some functions in response to detecting or predicting an increase in the number of switching-type vehicles and cooperative-type vehicles within the traveling area, regardless of the number of independent-type vehicles present within the traveling area. As a result, resources of the server and the relevant vehicle can be flexibly allocated as resources for realizing each function by cooperating with other switching-type vehicles. As a result, various functions for the vehicle can be provided flexibly.

(5) In the above item (4), the first reallocation execution step may further include: a second detection step of detecting or predicting a decrease in the number of cooperative-type vehicles or the number of switching-type vehicles present within the traveling area, in response to the result of the determination in the second determination step indicating that the switching-type vehicle other than the relevant vehicle is present within the nearby area, with use of the computer; a fourth determination step of determining whether or not more resources of the server are to become available, in response to detecting or predicting a decrease in the number of cooperative-type vehicles or the number of switching-type vehicles present within the traveling area in the second detection step, with use of the computer; and a step of, in response to a result of the determination in the fourth determination step indicating that more resources of the server are to become available, executing coordination regarding resources of the server with the switching-type vehicle present in the nearby area, and switching at least some of the resources of the relevant vehicle that have been allocated to functions of the in-vehicle device to resources of the server based on a result of the coordination, with use of the computer.

With this configuration, it is possible to newly allocate resources of the server to some functions to which resources of the relevant vehicle have been allocated by coordinating resources of the server that have become available between vehicles and distributing these resources therebetween in response to detecting or predicting a decrease in the number of switching-type vehicles and cooperative-type vehicles within the traveling area, regardless of the number of independent-type vehicles present within the traveling area. As a result, resources of the server and the relevant vehicle can be flexibly allocated as resources for realizing each function to reduce the load on the relevant vehicle. As a result, various functions for the vehicle can be provided flexibly.

(6) In the above item (3), the first reallocation execution step may include: a second detection step of detecting or predicting a decrease in the number of cooperative-type vehicles or the number of switching-type vehicles present within the traveling area, in response to the result of the determination in the second determination step indicating that the switching-type vehicle other than the relevant vehicle is present within the nearby area, with use of the computer; a third determination step of determining whether or not more resources of the server are to become available, in response to detecting or predicting a decrease in the number of cooperative-type vehicles or the number of switching-type vehicles present within the traveling area in the second detection step, with use of the computer; and a step of, in response to a result of the determination in the third determination step indicating that more resources of the server are to become available, switching at least some of the resources of the relevant vehicle that have been allocated to functions of the in-vehicle device to resources of the server, with use of the computer.

With this configuration, it is possible to newly allocate resources of the server to some functions to which resources of the relevant vehicle have been allocated by coordinating resources of the server that have become available between vehicles and distributing these resources therebetween in response to detecting or predicting a decrease in the number of switching-type vehicles and cooperative-type vehicles within the traveling area, regardless of the number of independent-type vehicles present within the traveling area. As a result, resources of the server and the relevant vehicle can be flexibly allocated as resources for realizing each function to reduce the load on the relevant vehicle. As a result, various functions for the vehicle can be provided flexibly.

(7) In any one of the above items (3) to (6), the second reallocation execution step may include: an intra-area increase detection step of detecting or predicting an increase in the number of cooperative-type vehicles present within the traveling area, in response to the result of the determination in the second determination step indicating that the switching-type vehicle other than the relevant vehicle is not present within the nearby area, with use of the computer; a first server resource determination step of determining whether or not resources of the server are to become insufficient, in response to detecting or predicting an increase in the number of cooperative-type vehicles present within the traveling area in the intra-area increase detection step, with use of the computer; and a step of, in response to a result of the determination in the first server resource determination step indicating that resources of the server are to become insufficient, switching at least some of the resources of the server that have been allocated to functions of the in-vehicle device to resources of the relevant vehicle, with use of the computer.

With this configuration, it is possible to newly allocate resources of the relevant vehicle to some functions to which resources of the server have been allocated by coordinating resources of the server that are predicted to decrease between vehicles and distributing the resources therebetween in response to detecting or predicting an increase in the number of cooperative-type vehicles within the traveling area, regardless of the number of independent-type vehicles present within the traveling area. As a result, even if the number of cooperative-type vehicles within the traveling area increases, resources of the server and the relevant vehicle can be flexibly allocated as resources for realizing each function to reduce the load on the server. As a result, various functions for the vehicle can be provided flexibly.

(8) In the above item (7), the second reallocation execution step may further include: an intra-area decrease detection step of detecting or predicting a decrease in the number of cooperative-type vehicles present within the traveling area, in response to the result of the determination in the first server resource determination step indicating that resources of the server are to become insufficient, with use of the computer; a second server resource determination step of determining whether or not more resources of the server are to become available, in response to detecting or predicting a decrease in the number of cooperative-type vehicles present within the traveling area in the intra-area decrease detection step, with use of the computer; and a step of, in response to a result of the determination in the second server resource determination step indicating that more resources of the server are to become available, switching at least some of the resources of the relevant vehicle that have been allocated to functions of the in-vehicle device to resources of the server, with use of the computer.

With this configuration, when there are spare resources of the server, some resources of the relevant vehicle that have been allocated to execution of functions can be released and resources of the server can be allocated to the vehicle. As a result, it is possible to reduce the load on the relevant vehicle and flexibly provide various functions for the vehicle.

(9) In any of the above items (3) to (6), the second reallocation execution step includes: an intra-area decrease detection step of detecting or predicting a decrease in the number of cooperative-type vehicles present within the traveling area, in response to the result of the determination in the second determination step indicating that the switching-type vehicle other than the relevant vehicle is not present within the nearby area, with use of the computer; a first server resource determination step of determining whether or not more resources of the server are to become available, in response to detecting or predicting a decrease in the number of cooperative-type vehicles present within the traveling area in the intra-area decrease detection step, with use of the computer; and a step of, in response to a result of the determination in the first server resource determination step indicating that more resources of the server are to become available, switching at least some of the resources of the relevant vehicle that have been allocated to functions of the in-vehicle device to resources of the server, with use of the computer.

With this configuration, when there are spare resources of the server, some resources of the relevant vehicle that have been allocated to execution of functions can be released and resources of the server can be allocated to the vehicle. As a result, it is possible to reduce the load on the relevant vehicle and flexibly provide various functions for the vehicle.

(10) In any one of the above items (5), (6), (8), and (9), the server of the traveling area may include at least a first server, the functions of the in-vehicle device may include first functions and second functions that require faster response than the first functions, and the step of switching to resources of the server may include: a server configuration determination step of determining whether or not the server of the traveling area further includes a second server whose response is faster than the first server; and a step of allocating resources of the relevant vehicle to the second functions and allocating resources of the first server to the first functions in response to determining in the server configuration determination step that the server does not include the second server.

With this configuration, resources of the second server, rather than those of the relevant vehicle, can be allocated to a function that requires fast response. Therefore, it is possible to reduce the load on the relevant vehicle and flexibly provide various functions for the vehicle.

(11) In any one of the above items (5), (6), (8), and (9), the step of switching to resources of the server may further include: a step of allocating resources of the first server to the first functions and allocating resources of the second server to the second functions in response to determining in the server configuration determination step that the server includes the second server.

With this configuration, resources of the second server, rather than those of the relevant vehicle, can be allocated to a function that requires fast response, and resources of the first server can be allocated to a function that does not require fast response. Therefore, it is possible to reduce the load on the relevant vehicle and flexibly provide various functions for the vehicle.

(12) In any one of the above items (5), (6), (8), and (9), the server of the traveling area may include at least a first server, the functions of the in-vehicle device may include first functions and second functions that require faster response than the first functions, and the step of switching to resources of the server may include: a server configuration determination step of determining whether or not the server of the traveling area further includes a second server whose response is slower than the first server; and a step of allocating resources of the first server to the first functions and the second functions in response to determining in the server configuration determination step that the server does not include the second server.

With this configuration, resources of the relevant vehicle can be allocated to a function that requires fast response, and resources of the first server can be allocated to a function that does not require fast response. Since the resources of the first server is allocated to the function that does not require fast response, the resources of the relevant vehicle can be effectively used for the function that requires fast response. As a result, it is possible to flexibly provide various functions for the vehicle while reducing the load on the relevant vehicle.

(13) In the above item (12), the step of switching to resources of the server further may include: a step of allocating resources of the second server to the first functions and allocating resources of the first server to the second functions, in response to determining in the server configuration determination step that the server includes the second server.

With this configuration, resources of the second server can be allocated to a function that requires fast response, and resources of the first server can be allocated to a function that does not require fast response. As a result, it is possible to allocate resources of the relevant vehicle to yet another function and to flexibly provide various functions for the vehicle while reducing the load on the relevant vehicle.

(14) In the above item (5) or (6), the server of the traveling area may include a first server and a second server whose response is faster than the first server, the functions of the in-vehicle device may include first functions and second functions that require faster response than the first functions, and the step of switching to resources of the server may include: a step of allocating, to the second functions, as many resources of the second server as the second server allows; a step of allocating, to the first functions, as many resources of the first server and resources of the second server as the first server and the second server allow; and a step of allocating resources of the relevant vehicle to a function that is included in the second functions and to which resources of the second server are not allocatable, and to a function that is included in the first functions and to which neither resources of the first server nor resources of the second server are allocatable.

With this configuration, as many of the resources of the second server as possible can be allocated to a function that requires fast response. Further, as many of the resources of the first and second sever as possible can be allocated to a function that does not require fast response. Accordingly, the load on the relevant vehicle is reduced, and resources of the vehicle are allocated to other functions. As a result, various functions for the vehicle can be provided flexibly.

(15) In the above item (14), the step of allocating, to the second functions, as many resources of the second server as the second server allows may include: an allocation determination step of determining whether or not resources of the second server are allocatable to all of the second functions; a step of allocating resources of the second server to all of the second functions in response to determining in the allocation determination step that resources of the second server are allocatable to all of the second functions; a step of, in response to determining in the allocation determination step that resources of the second server are not allocatable to at least some of the second functions, executing coordination regarding allocation of resources of the second server with another switching-type present within the traveling area, and allocating as many resources of the second server as possible to the at least some of the second functions in accordance with a result of the coordination; and a step of allocating resources of the relevant vehicle to a function that is included in the second functions and to which resources of the second server are not allocatable based on the result of the coordination.

If, as a result of this configuration, resources of the second server can be allocated to all of the second functions that require fast response, the resources of the second server can be allocated to all of the second functions without coordination with other vehicles. The relevant vehicle gains more available resources, and various other functions can be realized. Even when resources of the second server cannot be allocated to some of the second functions, it is possible to enable vehicles within the traveling area to effectively use the resources of the second server and to allocate as many of the resources of the second server as possible to the functions of the relevant vehicle itself by coordinating with other switching-type vehicles. As a result, it is possible to provide various functions by effectively using the resources of the second server not only for the relevant vehicle but also for the other vehicles within the traveling area.

(16) In the above item (14) or (15), the step of allocating, to the first functions, as many resources of the first server and resources of the second server as the first server and the second server allow may include: an additional determination step of determining whether or not resources of the first server are allocatable to all of the first functions; a step of allocating resources of the first server to all of the first functions in response to determining in the additional determination step that resources of the first server are allocatable to all of the first functions; a step of, in response to determining in the additional determination step that resources of the first server are not allocatable to at least some of the first functions, executing coordination regarding allocation of resources of the first server with another cooperative-type vehicle and another switching-type vehicle that are present within the traveling area, and allocating as many resources of the first server as possible to the at least some of the first functions in accordance with a result of the coordination; and a step of allocating resources of the relevant vehicle to a function that is included in the first functions and to which resources of the first server are not allocatable based on the result of the coordination.

If, as a result of this configuration, resources of the first server can be allocated to all of the first functions, the resources of the first server can be allocated to all of the first functions without coordination with other vehicles. The relevant vehicle gains more available resources, and various other functions can be realized. Even when resources of the first server cannot be allocated to some of the first functions, it is possible to enable vehicles within the traveling area to effectively use the resources of the first server by coordinating with the other switching-type vehicles. Furthermore, the relevant vehicle can allocate as many resources of the first server as possible to the first functions of the vehicle, and then allocate the resources of the vehicle to the remaining first functions. As a result, it is possible to provide various functions, including the first functions, by effectively using the resources of the first server not only for the relevant vehicle but also for the other vehicles within the traveling area.

(17) A resource allocation apparatus according to the second aspect of the present disclosure is a resource allocation apparatus for use in an in-vehicle device that provides driving assistance functions by communicating with a server. The in-vehicle device is a switching type in-vehicle device that allocates resources to each function of the in-vehicle device while switching between resources of a server covering a traveling area of a vehicle equipped with the in-vehicle device and resources of a relevant vehicle being the vehicle equipped with the in-vehicle device. The resource allocation apparatus includes: an allocation execution unit for executing allocation processing to allocate, to each function of the in-vehicle device, resources of the server covering the traveling area of the relevant vehicle and resources of the relevant vehicle; and an allocation re-execution unit for re-executing the allocation processing in response to detecting or predicting a change in the number of vehicles that are present in the traveling area and that cooperate with the server.

With this configuration, resources of the server and the vehicle can be flexibly allocated as resources for realizing each function in accordance with changes in the number of vehicles that are present within the traveling area and cooperate with the server. As a result, various functions for the vehicle can be provided flexibly.

(18) A computer program according to the third aspect of the present disclosure is a computer program causing a computer to allocate resources in an in-vehicle device that provides driving assistance functions by communicating with a server. The in-vehicle device is a switching type in-vehicle device that allocates resources to each function of the in-vehicle device while switching between resources of a server covering a traveling area of a vehicle equipped with the in-vehicle device and resources of a relevant vehicle being the vehicle equipped with the in-vehicle device. The computer program causes the computer to function as: an allocation execution unit for executing allocation processing to allocate, to each function of the in-vehicle device, resources of the server covering the traveling area of the relevant vehicle and resources of the relevant vehicle; and an allocation re-execution unit for re-executing the allocation processing in response to detecting or predicting a change in the number of vehicles that are present in the traveling area and that cooperate with the server.

With this configuration, resources of the server and the vehicle can be flexibly allocated as resources for realizing each function in accordance with changes in the number of vehicles that are present within the traveling area and cooperate with the server. As a result, various functions for the vehicle can be provided flexibly.

### Details of Embodiments of the Present Disclosure

Specific examples of a resource allocation method and apparatus and a computer program according to the embodiments of the present disclosure will be described below with reference to the drawings. Note that the present disclosure is not limited to these examples but is defined by the claims, and is intended to include all changes made within the meaning and scope equivalent to the claims.

### I. FIRST EMBODIMENT

### 1. Background of the Disclosure

In some driving assistance systems, sensors are installed in a vehicle and an in-vehicle device performs all information processing for sensor data. Since processing for the data is executed at the location where the sensor data was obtained, this method is advantageous for processing that needs to be performed in real time. In the present specification, the function of executing information processing for driving assistance with the in-vehicle device is referred to as an “in-vehicle edge server”.

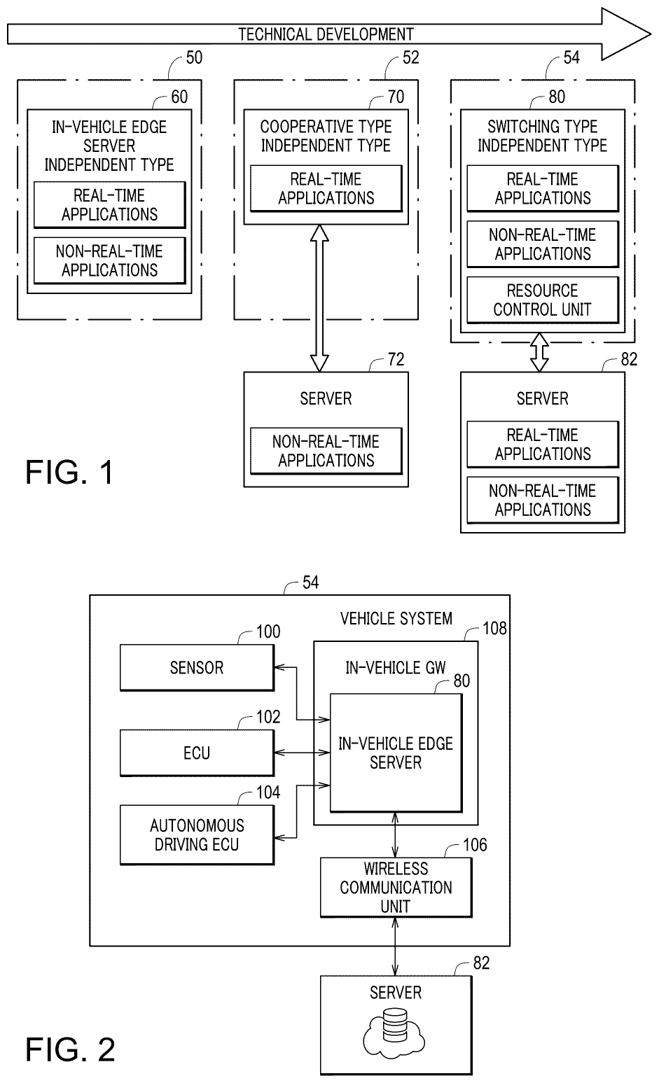

FIG. 1 schematically shows the technological development stages of vehicle systems equipped with an in-vehicle edge server. Referring to FIG. 1, an initial vehicle system 50 includes an in-vehicle edge server 60 of an independent type that is separated from other vehicles or the like, and various sensors (not shown). The in-vehicle edge server 60 of the independent type includes applications that process sensor data from these sensors. As these applications, both real-time applications, which realize functions essential to vehicle safety, and non-real-time applications, which do not directly contribute to vehicle safety, are executed. In the present specification, a vehicle equipped with such an in-vehicle edge server 60 of the independent type is referred to as an “independent-type vehicle”.

However, the in-vehicle edge server 60 of this type has a problem in that, for example, wide-area information cannot be used in driving assistance. Moreover, information obtained from the sensors in the vehicle equipped with the in-vehicle edge server 60 cannot be used in driving of other vehicles.

A vehicle system 52 at the next development stage compensates for the shortcomings of the above-described vehicle system 50 of the independent type, and includes an in-vehicle edge server 70 capable of communicating with a server 72 that covers a predetermined area, in addition to sensors (not shown). The in-vehicle edge server 70 executes real-time applications. Meanwhile, the server 72 executes non-real-time applications using sensor data transmitted from the in-vehicle edge server 70. The server 72 transmits the results of executing the non-real-time applications to the in-vehicle edge server 70. The in-vehicle edge server 70 uses the information in driving assistance.

The in-vehicle edge server 70 thus performs driving assistance processing in conjunction with the server 72. Accordingly, the in-vehicle edge server 70 is called an “in-vehicle edge server of a cooperative type”. Further, a vehicle equipped with the in-vehicle edge server of the cooperative type is referred to as a “cooperative-type vehicle”. The in-vehicle edge server of the cooperative type is installed inside an in-vehicle gateway (hereinafter referred to as an “in-vehicle GW (Gateway)”) that handles communication between each part of the vehicle and external devices.

It is also possible to consider, as a vehicle system 54 at a more advanced stage than the vehicle system 52, a vehicle system equipped with an in-vehicle edge server 80 of a switching type that can communicate with a server 82 and other vehicles or the like. The in-vehicle edge server 80 can switch the execution of both real-time and non-real-time applications between the in-vehicle edge server 80 and the server 82. For this purpose, the in-vehicle edge server 80 includes a resource control unit for controlling whether to allocate, to the applications, resources of the vehicle (hereinafter referred to as a “relevant vehicle”) equipped with the in-vehicle edge server 80 or resources of the server 82. A vehicle equipped with such an in-vehicle edge server 80 of the switching type is referred to as a switching-type vehicle.

Thus, while there are technological development stages of in-vehicle edge servers, in-vehicle edge servers that are used in society are not uniformly (i.e., simultaneously) replaced by higher-level in-vehicle edge servers. It is expected that vehicles equipped with in-vehicle edge servers of the independent type, cooperative type, and switching type will coexist on the roads. In such cases, various problems related to resources of the server may arise.

### 2. Configuration

### 2A. Hardware Configuration

For example, the vehicle system 54 shown in FIG. 1 has the following schematic configuration. Referring to FIG. 2, the vehicle system 54 includes a sensor 100, an electronic control unit (ECU) 102, an autonomous driving ECU 104, a wireless communication unit 106 for communicating with the server 82, and an in-vehicle GW 108 for relaying and distributing communication between each part of the vehicle system 54 and the server 82 via the wireless communication unit 106. The in-vehicle GW 108 includes the in-vehicle edge server 80. The in-vehicle edge server 80 is connected to the sensor 100, the ECU 102, the autonomous driving ECU 104, and the wireless communication unit 106. The in-vehicle edge server 80 is configured to process sensor data from the sensor 100 within the in-vehicle edge server 80, and to transmit data to the server 82 via the wireless communication unit 106 and receive the results of the server 82 executing applications. The in-vehicle edge server 80 provides such information to the ECU 102, the autonomous driving ECU 104, and the like for use in driving assistance.

Note that only one sensor 100 and one ECU 102 are shown in FIG. 2. However, in reality, one or more sensors of different types are present as the sensor 100, and one or more ECUs of different functions are present as the ECU 102. The ECU 102 is substantially a computer and serves to execute a designated program and output the results to other ECUs or the like, or to control each part of the vehicle by executing a program.

The vehicle system 50 shown in FIG. 1 does not include the wireless communication unit 106 in FIG. 2. The vehicle system 52 has the same hardware configuration as FIG. 2.

### 2B. Functional Configuration

A problem that may arise in relation to a vehicle 320 equipped with the in-vehicle edge server 80 according to the first embodiment is described below. Note that in the following embodiment, an area in which the vehicle 320 is traveling is referred to as a “traveling area”. An area adjacent to the traveling area and covered by another server is referred to as an “adjacent area”. The traveling area and the adjacent area are collectively referred to as a “nearby area”. A vehicle traveling in the nearby area is referred to as a “nearby vehicle”. Note that there are two types of servers, namely a cloud server and an edge server. The cloud server often handles a wider area than the edge server. The edge server handles a narrower region. Thus, the edge server can process requests from vehicles more rapidly than the cloud server.

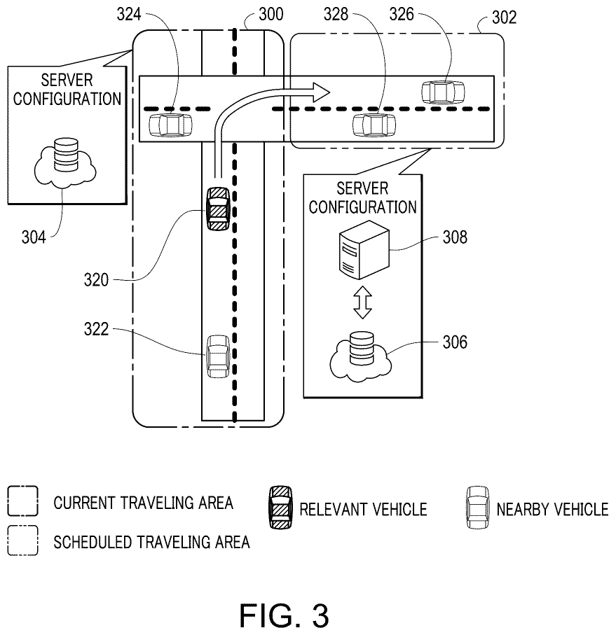

Referring to FIG. 3, a traveling area 300 denotes the traveling area of the vehicle 320. A cloud server 304 denotes the server covering the traveling area 300. An adjacent area 302 denotes an area adjacent to the traveling area 300, and the server covering the adjacent area 302 is a combination of a cloud server 306 and an edge server 308. The cloud server 306 covers a wide region of the adjacent area 302, and the edge server 308 covers a narrow region within the adjacent area 302. The cloud server 306 processes processing requests from vehicles that cannot communicate with the edge server 308 among vehicles in the adjacent area 302. The cloud server 306 also processes processing requests from the edge server 308. Originally, the coverage area of the edge server 308 is narrower than that of the cloud server 306, and the time required for communication between each vehicle and the edge server 308 is shorter than the time required for communication between each vehicle and the cloud server 306. Therefore, the edge server 308 responds faster to processing requests from each vehicle than the cloud server 306.

In the example shown in FIG. 3, other vehicles 322 and 324 are present within the traveling area 300 of the vehicle 320. Also, vehicles 326 and 328 are present in the adjacent area 302. Thus, vehicles other than a certain vehicle, namely the vehicle 320, that are present in the traveling area of the vehicle 320 and another traveling area adjacent to the traveling area of the vehicle 320 are nearby vehicles for the vehicle 320, as mentioned above. At least the server covering each area ascertains and manages the type of each vehicle present in the area, i.e., whether each vehicle is the aforementioned independent-type vehicle, cooperative-type vehicle, or switching-type vehicle, together with vehicle information such as the position, movement speed, and vehicle model of the vehicle. The servers covering adjacent areas exchange such information regarding the vehicles. Therefore, each server ascertains and manages at least the position and the movement direction and speed (hereinafter referred to as “vehicle movement status”) of each vehicle present in its own coverage area and the area adjacent to the coverage area, as well as the type of the vehicle. As a result, if, for example, the vehicle 320 wants to check the type, the vehicle movement status, or the like of a nearby vehicle, the vehicle 320 can make an inquiry to the cloud server 304.

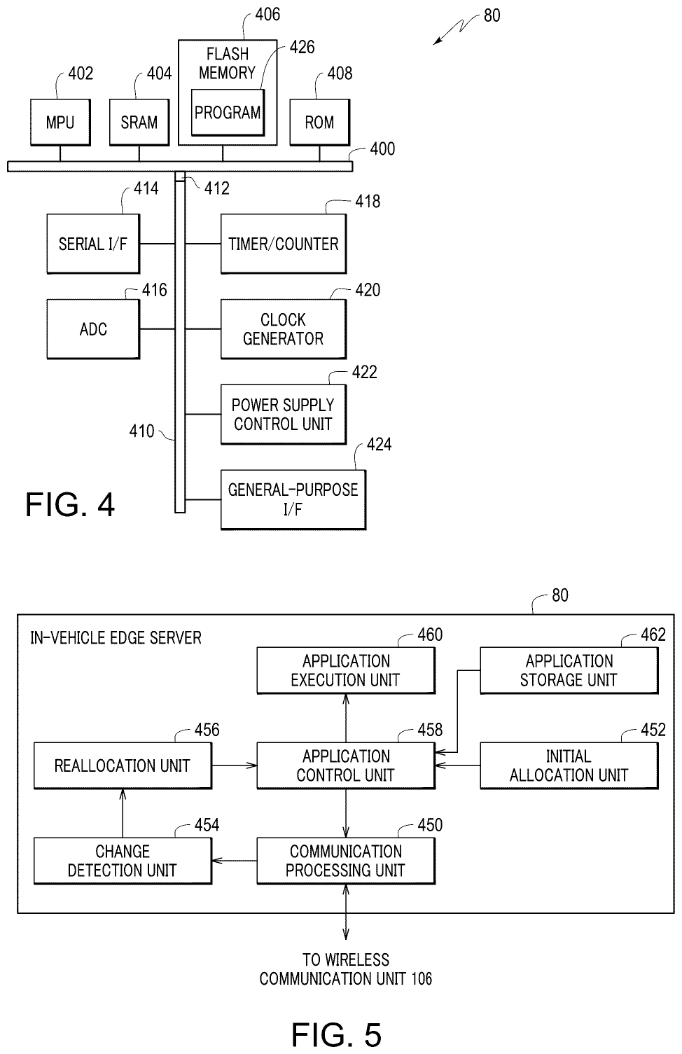

FIG. 4 shows a hardware configuration of a micro controller unit (MCU) that constitutes the in-vehicle edge server 80. Referring to FIG. 4, the MCU includes a micro-processing unit (MPU) 402, which is a processor, a high-speed bus 400 to which the MPU 402 is connected, a static random access memory (SRAM) 404 connected to the high-speed bus 400, a flash memory 406 connected to the high-speed bus 400, and a read-only memory (ROM) 408 connected to the high-speed bus 400. The SRAM 404 holds data necessary for executing programs, for example. The flash memory 406 stores programs 426, which includes, for example, programs for realizing the functions realized by the in-vehicle edge server 80 (including both real-time applications and non-real-time applications) and programs for controlling resources. The ROM 408 stores, for example, a boot-up program for the MPU 402.

The MCU also includes a low-speed bus 410 connected to the high-speed bus 400 via a bridge 412, as well as a serial interface (I/F) 414, an analog-to-digital converter (ADC) 416, a timer/counter 418, a clock generator 420, a power supply control unit 422, and a general-purpose I/F 424, all of which are connected to the low-speed bus 410.

Since the operation of the MCU is well known and it is the function of the program the MCU executes that is meaningful in the embodiment, the operation of the MCU itself is not described in the following description.

FIG. 5 is a block diagram showing a functional configuration of the in-vehicle edge server 80. Referring to FIG. 5, functionally, the in-vehicle edge server 80 includes an initial allocation unit 452 for executing initial allocation of resources of the relevant vehicle or a server with which the relevant vehicle can communicate, to each function realized by the in-vehicle edge server 80 when the in-vehicle edge server 80 starts, and a communication processing unit 450 connected to the wireless communication unit 106 shown in FIG. 2.

The in-vehicle edge server 80 also includes a change detection unit 454 connected to the communication processing unit 450 for detecting or predicting a change (increase/decrease) that has occurred in the number of switching-type vehicles and cooperative-type vehicles in the traveling area 300, and a reallocation unit 456 for reallocating resources of the relevant vehicle and the server to the applications provided by the in-vehicle edge server 80 in accordance with the situation after the change in response to the change detection unit 454 detecting or predicting the change.

The in-vehicle edge server 80 also includes an application storage unit 462 for storing the real-time applications and the non-real-time applications, and an application control unit 458 for controlling execution of the applications in response to the initial resources allocation by the initial allocation unit 452 and the resource reallocation by the reallocation unit 456 such that applications read out from the application storage unit 462 are executed by the allocated resources (of the relevant vehicle or the server). The in-vehicle edge server 80 also includes an application execution unit 460 for executing an application designated by the application control unit 458 to be executed with resources of the relevant vehicle. The application execution unit 460 includes, for example, the ECU 102 and the autonomous driving ECU 104 shown in FIG. 2.

An application designated by the application control unit 458 to be executed by the server is transmitted to the server via the communication processing unit 450 and the wireless communication unit 106 shown in FIG. 2, and executed by the server. Alternatively, the application control unit 458 transmits an identifier of the application to the server, thus causing the server to execute an application having an equivalent function.

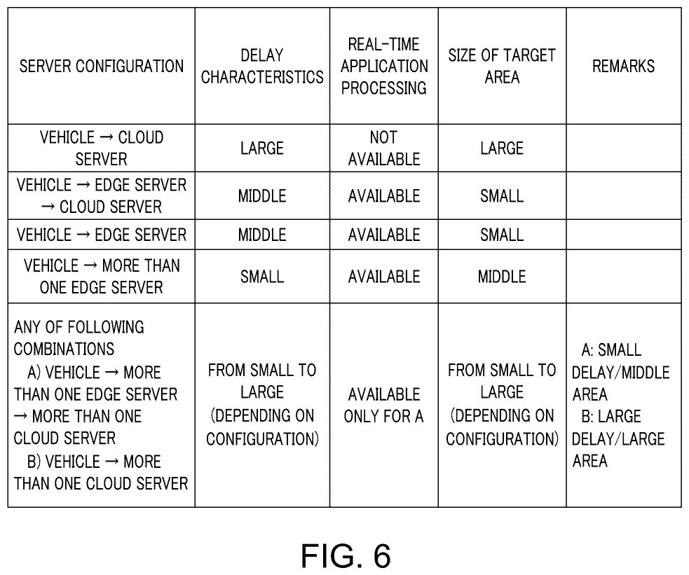

The resource allocation to the applications varies depending on the increase or decrease in the number of cooperative-type vehicles and switching-type vehicles in the traveling area, and the configuration of the server. FIG. 6 shows, in tabular form, server configurations, as well as delay characteristics, whether real-time applications can be executed, and the size of a target area (server coverage area) in each server configuration.

In this embodiment, the server configurations considered here include “a cloud server only”, “a cloud server and an edge server”, “one edge server only”, and “some combinations of more than one edge server and more than one cloud server”, as shown in FIG. 6. Of these, the delay is large when only a cloud server is used, and the delay is small or medium when an edge server is used. In the case of the combinations of more than one cloud server and more than one edge server, the delay varies depending on the combination. Therefore, if the server configuration includes only a cloud server, real-time applications cannot be executed.

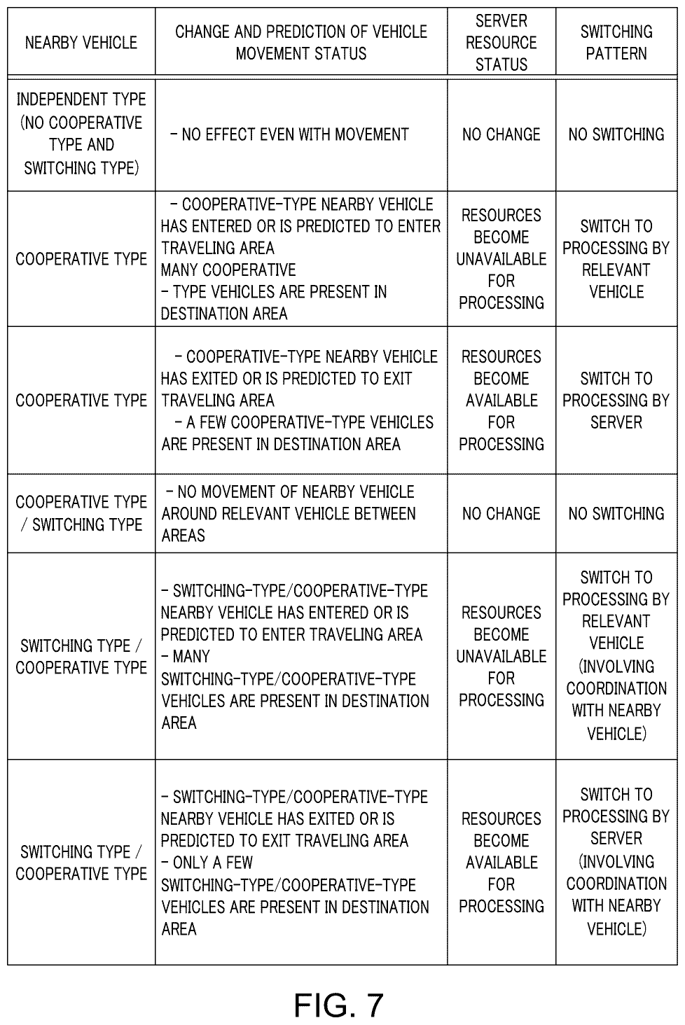

FIG. 7 shows, in tabular form, how to switch resources for each type of vehicle included in the nearby vehicles in response to changes and predictions of the vehicle movement status related to the traveling area, as well as the server resource status.

Referring to the first row of FIG. 7, if, for example, the nearby vehicles are of the independent type only, and no cooperative-type and switching-type vehicles are present, no change occurs in the server resource status when the nearby vehicles enter the traveling area. The same applies to the cases where a nearby vehicle exits the traveling area, the relevant vehicle moves from the traveling area to one of the adjacent areas, or such a movement is predicted. Therefore, the resources need not be switched for the relevant vehicle (switching-type vehicle).

On the other hand, consider the case where the nearby vehicles include a cooperative-type vehicle, for example. Here, the nearby vehicles may also include an independent-type vehicle, but do not include a switching-type vehicle. The second and third rows in FIG. 7 show server resource statuses and switching patterns in the cases where the number of cooperative-type vehicles within the traveling area of the relevant vehicle increases and decreases, respectively.

The “case where the number of cooperative-type vehicles within the traveling area of the relevant vehicle increases” refers, for example, to the case where a cooperative-type vehicle present within an adjacent area enters or is predicted to enter the traveling area. Another example is the case where the relevant vehicle moves or is predicted to move from its current traveling area to another adjacent traveling area, and more cooperative-type vehicles are present within the destination area than those within the current traveling area. In this case, the number of available resources of the server will generally decrease, and in some cases the resources of the server will become unavailable. Then, an application to which resources of the server have been allocated will need to be reallocated resources of the server or the relevant vehicle; that is, the relevant vehicle will need to take over the processing of the application.

The “case where the number of cooperative-type vehicles within the traveling area of the relevant vehicle decreases” refers, for example, to the case where a cooperative-type vehicle present within the traveling area exits or is predicted to exit the traveling area. Another example is the case where the relevant vehicle moves or is predicted to move from its current traveling area to another adjacent traveling area, and less cooperative-type vehicles are present within the destination area than those within the current traveling area. In this case, the number of available resources of the server will generally increase. In that case, there is a possibility that resources of the server can be allocated to a non-real-time application to which resources of the relevant vehicle have been allocated. Accordingly, if resources of the server are available, the application to which resources of the relevant vehicle have been allocated can be reallocated resources of the server; that is, the server can take over the processing of the application.

The information shown in fourth, fifth, and sixth rows in FIG. 7 can also be interpreted in a similar manner. However, another switching-type vehicle is involved in these cases. The other switching-type vehicle also attempts to reallocate resources similarly to the relevant vehicle. Therefore, there is a possibility of a conflict with the switching-type vehicle regarding the reallocation of resources of the server. In such a case, coordination of resources between the switching-type vehicles would be required.

### 2C. Program Configuration

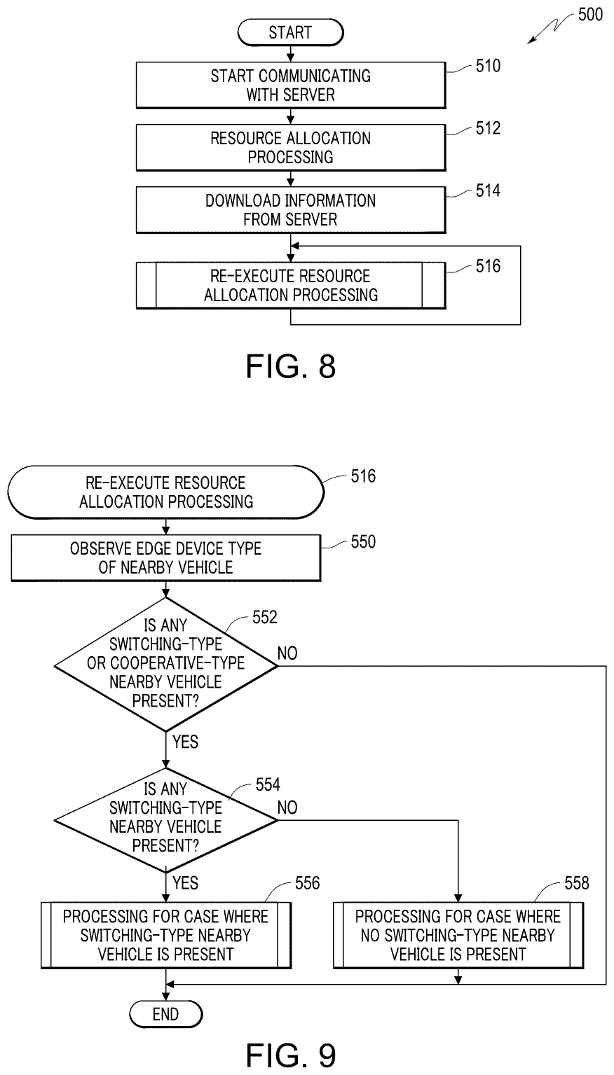

FIG. 8 and subsequent figures show a control structure of a program executed by the MPU 402 shown in FIG. 4 to realize the functions of the in-vehicle edge server 80 shown in FIG. 5.

Referring to FIG. 8, this program 500 includes step 510 of starting communication with the server upon startup, and step 512, following step 510, of performing initial allocation of resources of the relevant vehicle and resources of the server to each application that realizes functions used by the in-vehicle device. The allocation processing in step 512 may be performed in any method. For example, it is conceivable to make an inquiry about available resources to the server, allocate resources in a range permitted by the server to non-real-time applications, and allocate resources of the relevant vehicle to the remaining applications. Here, it is assumed that the cloud server 304 shown in FIG. 3 is the server with which the in-vehicle device starts communication when the program 500 starts.

The program also includes step 514 of downloading, from the server, information regarding vehicles in the nearby area including the traveling area, and step 516 of re-executing resource allocation processing in response to a change being detected or predicted in the number of cooperative-type vehicles or switching-type vehicles within the traveling area based on the information downloaded in step 514, and then returning the control to step 514. If no change is involved in the number of cooperative-type vehicles or switching-type vehicles within the traveling area, the control returns to step 514.

Referring to FIG. 9, step 516 of re-executing allocation processing shown in FIG. 8 has the following control structure. Step 516 includes step 550 of observing and judging the types of edge devices of the nearby vehicles based on the vehicle information downloaded in step 514, and step 552 of determining whether the nearby vehicles include any vehicle other than an independent-type vehicle, i.e., a switching-type vehicle or a cooperative-type vehicle, based on the judgment result in step 550, and branching the control flow in accordance with the determination result.

If it is determined in step 552 that the nearby vehicles include a switching-type vehicle or a cooperative-type vehicle, the control proceeds to step 554. In step 554, the MPU 402 branches the control flow in accordance with whether the nearby vehicles include a switching-type vehicle. If a switching-type vehicle is present, the control proceeds to step 556, where the MPU 402 executes processing for the case where a switching-type nearby vehicle is present, and terminates step 516. If no switching-type vehicle is present, the control proceeds to step 558, where the MPU 402 executes processing for the case where no switching-type nearby vehicle is present, and terminates step 516.

If it is determined in step 552 that the nearby vehicles do not include a switching-type vehicle or a cooperative-type vehicle, it means that the nearby vehicles only include an independent-type vehicle and a vehicle without an in-vehicle edge server. These nearby vehicles do not use resources of the server. Thus, the MPU 402 need not reallocate resources to the functions of the relevant vehicle. Therefore, in this case, the MPU 402 terminates processing in step 516.

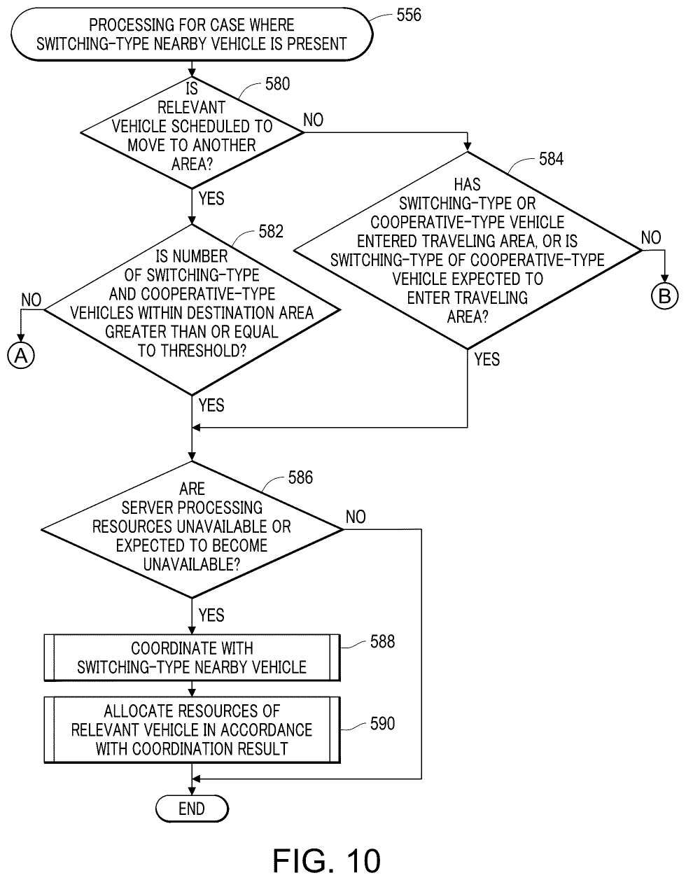

Referring to FIG. 10, step 556 in FIG. 9 has the following control structure. Step 556 includes step 580 of branching the control flow based on whether the relevant vehicle is scheduled to move to another area, and step 582 of, when the determination result in step 580 is “Yes”, branching the control flow based on whether the number of switching-type vehicles and cooperative-type vehicles within the destination area is greater than or equal to a threshold. Step 556 also includes step 584 of, when the determination result in step 580 is “No”, branching the control flow in accordance with whether a switching-type vehicle or a cooperative-type vehicle has entered or is expected to enter the traveling area.

If the determination result in step 582 is “Yes”, or if the determination result in step 584 is “Yes”, the control proceeds to step 586. In step 586, the MPU 402 determines whether the server has no available processing resources or is expected to exhaust available processing resources, and branches the control flow. If the determination result in step 586 is “No”, step 556 terminates. That is, in this case, resources are not reallocated.

If the determination result in step 586 is “Yes”, the control proceeds to step 588. In step 588, the MPU 402 coordinates reallocation of resources with the switching-type nearby vehicle. The control further proceeds to step 590, where the MPU 402 performs reallocation processing to allocate resources of the relevant vehicle to some or all of the applications to which resources of the server have been allocated, in accordance with the coordination result in step 588, and terminates step 556. Note that there may be a case where resources are not reallocated in step 590 depending on the coordination result in step 588.

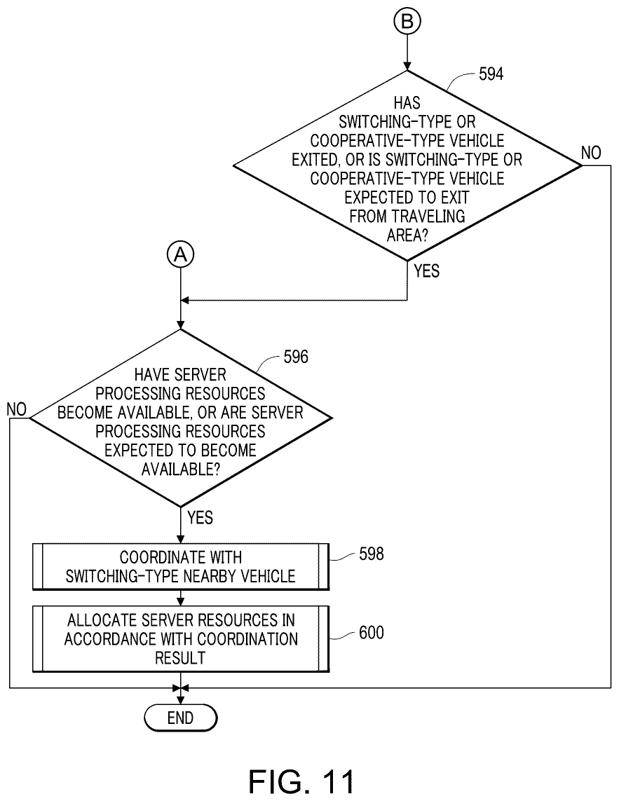

Referring to FIG. 11, if the determination result in step 584 in FIG. 10 is “No”, the control proceeds to step 594 in FIG. 11. In step 594, the MPU 402 determines whether a switching-type vehicle or a cooperative-type vehicle has exited or is expected to exit the traveling area, and branches the control flow in accordance with the determination result. If the determination result in step 594 is “No”, the MPU 402 terminates processing in step 556.

The program further includes step 596, which is performed if the determination result in the step 582 in FIG. 10 is “No” or if the determination result in the step 594 in FIG. 11 is “Yes”. In step 596, it is determined whether resources of the server have become available or are expected to become available, and the control flow is branched in accordance with the determination result. If the determination result in step 596 is “No”, the MPU 402 terminates processing in step 556. If the determination result in step 596 is “Yes”, in step 598, the MPU 402 coordinates reallocation of resources with the switching-type nearby vehicle. In step 600, the MPU 402 also allocates resources of the server to some of the applications in accordance with the coordination result in step 598, and terminates step 556.

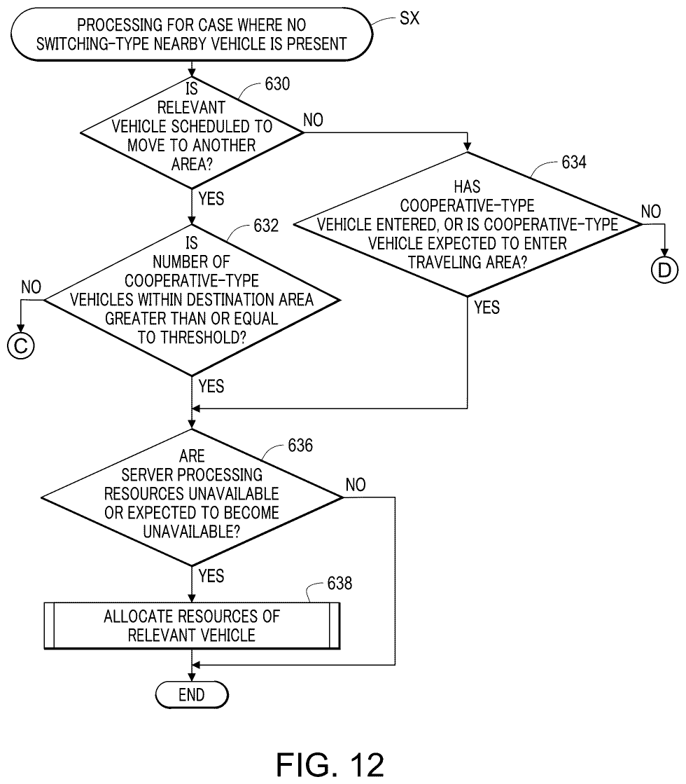

FIG. 12 shows a control structure of a program that realizes step 558 shown in FIG. 9. Referring to FIG. 12, step 558, which realizes processing for the case where no switching-type nearby vehicle is present, includes step 630 of branching the control flow depending on whether the relevant vehicle is scheduled to move to another traveling area, and step 632 of, if the determination result in step 630 is “Yes”, determining whether the number of cooperative-type vehicles present in the destination area is greater than or equal to a threshold, and branching the control flow in accordance with the determination result. Step 558 also includes step 634 of, if the determination result in step 630 is “No”, determining whether a cooperative-type nearby vehicle has entered or is expected to enter the traveling area, and branching the control flow in accordance with the determination result.

Step 558 further includes step 636 of, if the determination result in step 632 is “Yes” or the determination result in step 634 is “Yes”, branching the control flow in accordance with whether server processing resources are not available or are expected to become unavailable. If the determination result in step 636 is “No”, step 558 terminates. If the determination result in step 636 is “Yes”, the control proceeds to step 638, where the MPU 402 switches resources allocated to some or all of the applications to which resources of the server have been allocated, to resources of the relevant vehicle, and terminates step 558.

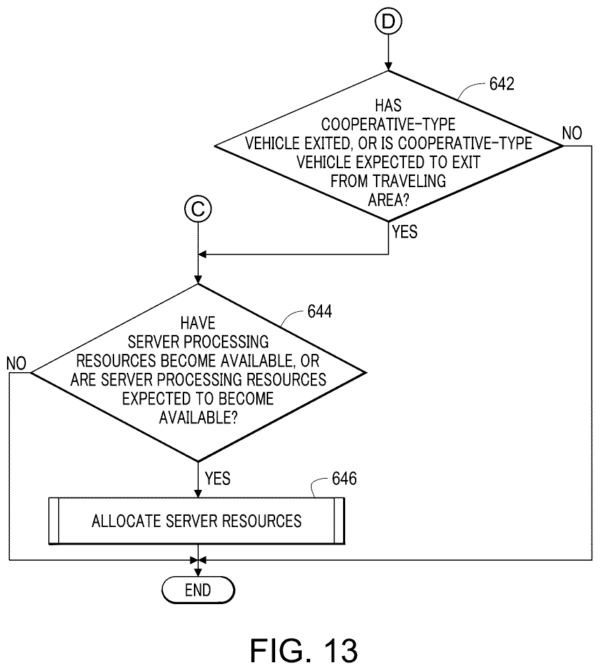

Referring to FIG. 13, step 558 further includes step 642, which is performed in response to the determination result in step 634 in FIG. 12 being “No”. In step 642, the control flow is branched in accordance with whether a cooperative-type vehicle has exited or is expected to exit the traveling area.

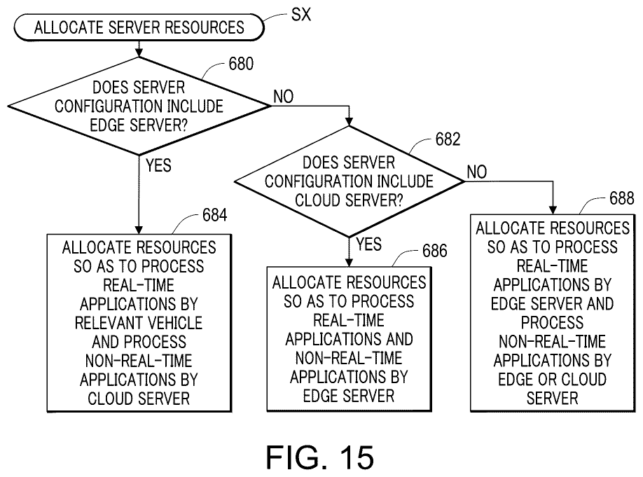

If the determination result in step 632 is “No” or the determination result in step 642 is “Yes”, the control proceeds to step 644. In step 644, the MPU 402 determines whether processing resources of the server have become available or are expected to become available, and branches the control flow. If the determination result in step 644 is “No”, the server has no available processing resources, and therefore step 558 terminates. If the determination result in step 644 is “Yes”, the control proceeds to step 646, and processing for allocating resources of the server to the applications is performed. After step 646 has been completed, step 558 terminates. The details of step 646 will be described later with reference to FIG. 15.

If the determination result in step 642 is “No”, step 558 terminates.

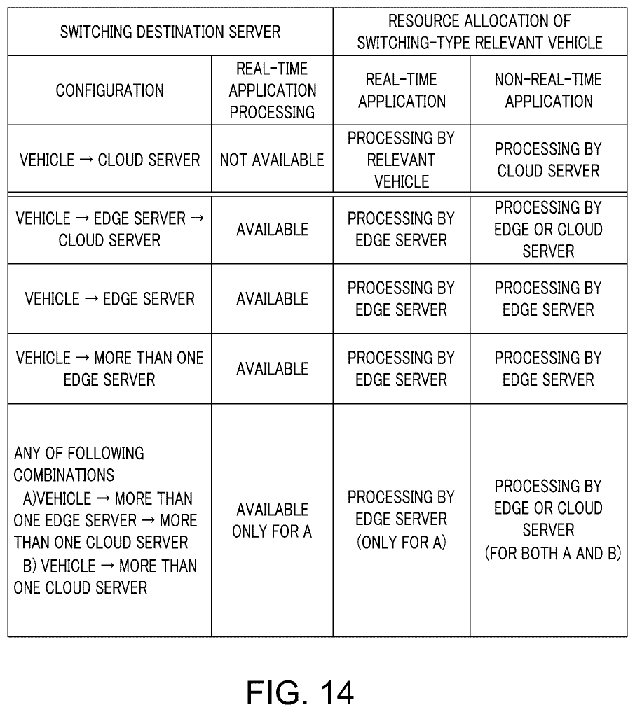

FIG. 14 shows, in tabular form, a policy by which a switching-type vehicle allocates resources to real-time applications and non-real-time applications with respect to each type of configuration of the switching destination server. Referring to FIG. 14, if, for example, the switching destination server includes only a cloud server (first row), real-time applications cannot be executed depending on the cloud server. Accordingly, the MPU 402 allocates resources of the relevant vehicle to real-time applications. Meanwhile, the MPU 402 basically allocates resources of the cloud server to the non-real-time applications.

When the server has a two-layer structure constituted by an edge server and a cloud server as indicated in the second row, the edge server can execute the real-time applications. Accordingly, the MPU 402 allocates resources of the edge server to the real-time applications. Meanwhile, both the edge server and the cloud server can process the non-real-time applications. Accordingly, resources of the edge server or the cloud server are allocated to the non-real-time applications depending on available resources of the respective servers.

The fifth row shows a resource allocation policy for the case where the server is a combination of more than one edge server and more than one cloud server, and the case where the server has only more than one cloud server. In these cases, the real-time applications can be executed on the server side (edge server) in an environment where the server configuration includes an edge server. Accordingly, the MPU 402 allocates resources of the edge server to the real-time applications. However, if the server configuration includes only cloud servers, the real-time applications cannot be executed on the server side. Accordingly, in this case, the MPU 402 allocates resources of the relevant vehicle to the real-time applications. In both cases, the MPU 402 allocates available resources on the server side to the non-real-time applications.

FIG. 15 shows a control structure of a program executed in step 646 in FIG. 13. Referring to FIG. 15, step 646, in which resources allocated to the applications are switched to those on the server side, includes step 680 of determining whether the server configuration includes an edge server and branching the control flow in accordance with the determination result, and step 684 of, in response to the determination result in step 680 being “No”, allocating resources of the relevant vehicle to the real-time applications and resources of the cloud server to the non-real-time applications. It is assumed in step 684 that the server covering the traveling area of the vehicle equipped with the MPU 402 includes a cloud server.

If the determination result in step 680 is “Yes”, the control proceeds to step 682. In step 682, the MPU 402 determines whether the server configuration includes a cloud server, and branches the control flow in accordance with the determination result.

If the determination result in step 682 is “No”, the control proceeds to step 686. If the determination result in step 682 is “No”, it means that the server configuration includes only an edge server(s). Accordingly, in step 686, the MPU 402 allocates resources of the edge server to both the real-time applications and the non-real-time applications, and terminates processing in step 646.

On the other hand, if the determination result in step 682 is “Yes”, the control proceeds to step 688. If the determination result in step 682 is “Yes”, it means that the server configuration includes both a cloud server(s) and an edge server(s). Accordingly, in step 688, the MPU 402 allocates resources of the edge server to the real-time applications, allocates resources of the edge server or the cloud server to the non-real-time applications depending on the resource status of the edge server, and terminates processing in step 646.

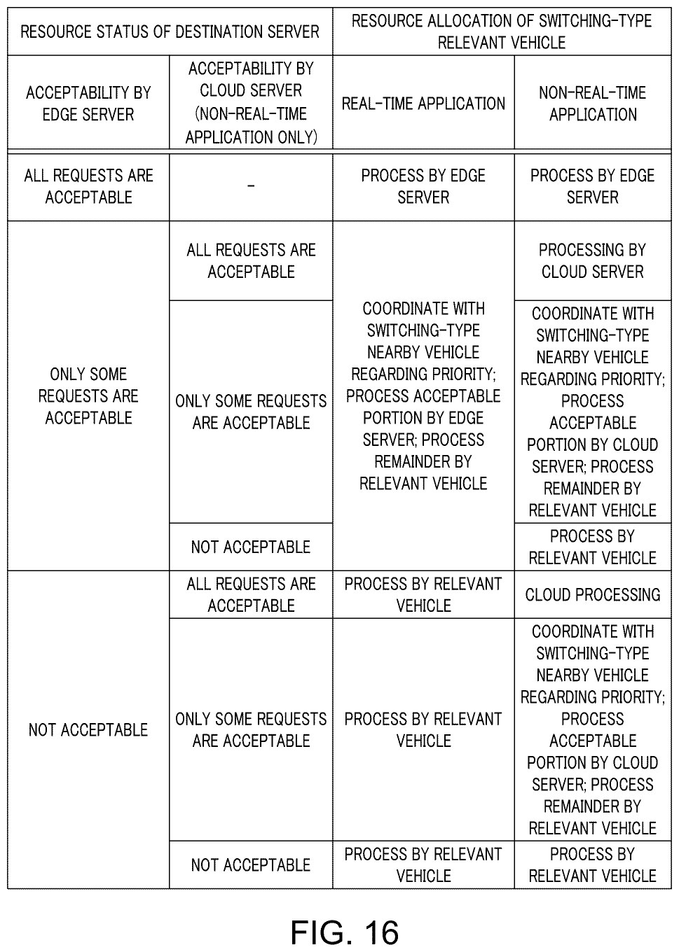

FIG. 16 shows, in tabular form, how a switching-type vehicle allocates resources to each application in accordance with the resource status of the switching destination server. Referring to FIG. 16, for example, the first row shows the case where, when the MPU 402 makes resource allocation requests to an edge server or a cloud server, the edge server can accept all requests. In this case, the cloud server need not accept any request. The switching-type vehicle allocates resources of the edge server to the real-time applications. The switching-type vehicle also allocates resources of the edge server to the non-real-time applications.

The second row shows the case where the edge server can accept only some of the allocation requests. In this case, for the real-time applications, the switching-type vehicle (relevant vehicle) coordinates the priority of resource allocation with a switching-type nearby vehicle. Based on the coordination result, the switching-type vehicle allocates resources of the edge server to some of the real-time applications to which resources of the edge server can be allocated. The switching-type vehicle allocates its own resources to the remaining real-time applications.

Meanwhile, for the non-real-time applications, the case where the edge server can accept only some of the allocation requests can be further divided into three cases depending on the status of the cloud server. In the first case, the cloud server can accept all of the allocation requests. In this case, the switching-type vehicle allocates resources of the cloud server to all of the non-real-time applications. In the second case, the cloud server can accept only some of the resource allocation requests. In this case, the switching-type vehicle coordinates the priority of resource allocation with a switching-type nearby vehicle. Based on the coordination result, the switching-type vehicle further allocates resources of the cloud server to some of the non-real-time applications for which the cloud server can accept the allocation requests. The switching-type vehicle allocates its own resources to the remaining non-real-time applications. In the third case, the cloud server cannot accept the resource allocation requests. In this case, the switching-type vehicle allocates its own resources to all of the non-real-time applications.

The third row shows the case where the edge server cannot accept the resource allocation requests. In this case, resources of the relevant vehicle are allocated to all of the real-time applications regardless of whether the cloud server can accept all of the resource allocation requests. For the non-real-time applications, resource allocation differs depending on whether the cloud server can accept all, some, or none of the allocation requests. If the cloud server can accept only some of the resource allocation requests, the switching-type vehicle coordinates the priority with a switching-type nearby vehicle. The switching-type vehicle allocates resources of the cloud server to some of the non-real-time applications for which the cloud server can accept the allocation requests, in accordance with the coordination result. The switching-type vehicle allocates its own resources to the remaining non-real-time applications.

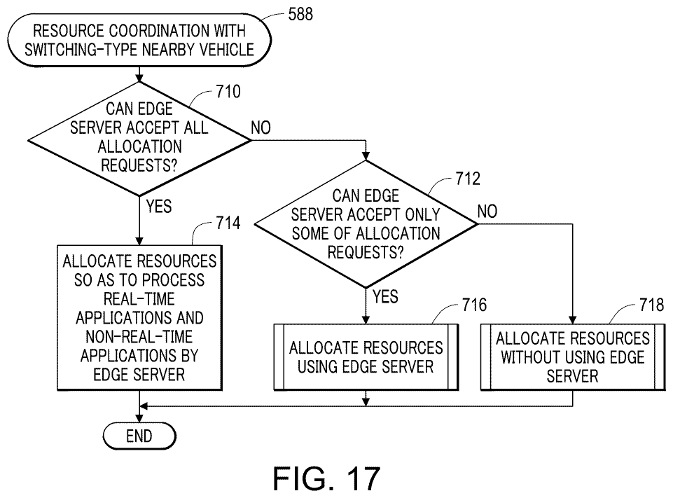

FIG. 17 is a flowchart illustrating a control structure of a program that realizes the coordination of the priority with a switching-type nearby vehicle that is executed in step 588 in FIG. 10 and step 598 in FIG. 11. Referring to FIG. 17, the program includes step 710 of determining whether the edge server can accept all of the resource allocation requests and branching the control flow in accordance with the determination result, and step 714 of, if the determination result in step 710 is “Yes”, allocating resources of the edge server to the real-time applications and also to the non-real-time applications, and terminating the processing.

The program further includes step 712 of, if the determination result in step 710 is “No”, determining whether the edge server can accept only some of the resource allocation requests, and branching the control flow in accordance with the determination result. If the determination result in step 712 is “Yes”, the control proceeds to step 716. In step 716, the MPU 402 allocates resources so as to use the edge server. If the determination result in step 712 is “No”, the control proceeds to step 718. In step 718, the MPU 402 allocates resources so as not to use the edge server.

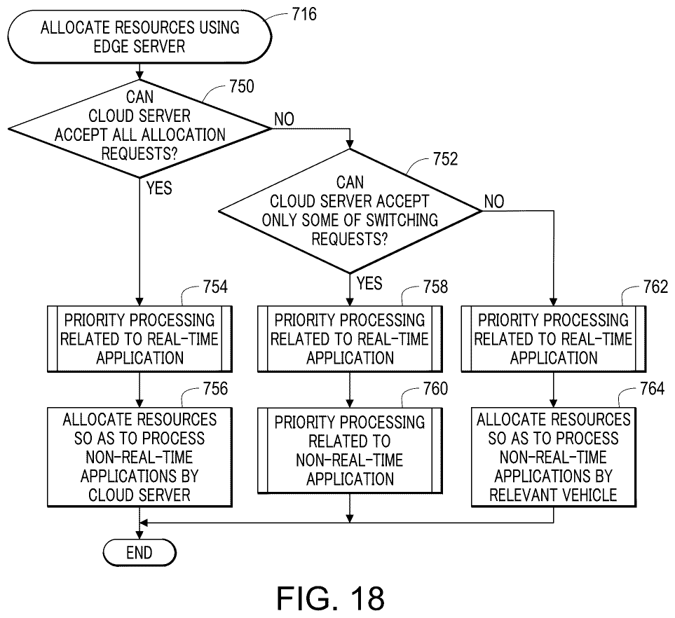

FIG. 18 illustrates a control structure of a program that realizes processing that is performed in step 716 in FIG. 17 to allocate resources so as to use the edge server. Referring to FIG. 18, the program includes step 750 of determining whether the cloud server can accept all of the resource allocation requests and branching the control flow in accordance with the determination result, step 754 of, if the determination result in step 750 is “Yes”, performing allocation for the real-time applications, and step 756, following step 754, of allocating resources of the cloud server to the non-real-time applications and terminating step 716.

The program also includes step 752 of, if the determination result in step 750 is “No”, determining whether the cloud server can accept only some of the resource allocation requests and branching the control flow in accordance with the determination result. If the determination result in step 752 is “Yes”, the control proceeds to step 758. If the determination result in step 752 is “No”, the control proceeds to step 762.

In step 758, the MPU 402 executes priority processing related to the real-time applications. In the following step 760, the MPU 402 executes priority processing related to the non-real-time applications, and terminates step 716. On the other hand, in step 762, the MPU 402 executes priority processing related to the real-time applications. In the following step 764, the MPU 402 allocates resources of the relevant vehicle to the non-real-time applications, and terminates step 716.

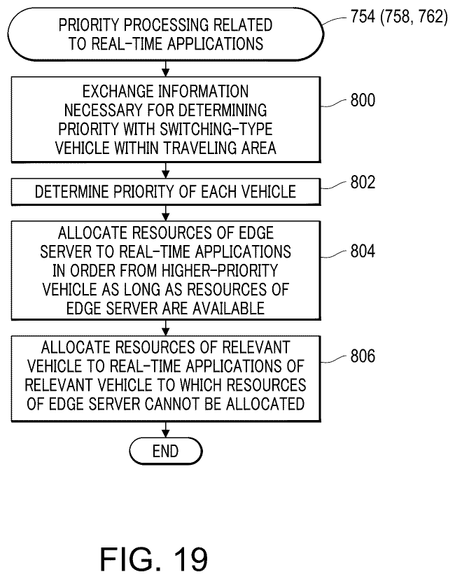

FIG. 19 shows the details of a program of the priority processing related to the real-time applications that is executed by the MPU 402 in steps 754, 758, and 762 in FIG. 18. Referring to FIG. 19, the program includes step 800 of exchanging information necessary to determine the priority with a switching-type vehicle present in the traveling area, and step 802 of determining the priority of each vehicle using information received in step 800 from the other switching-type vehicle and information regarding the relevant vehicle.

Various criteria can be used to determine the priority here. For example, in one possible method, emergency vehicles have the highest priority, business vehicles have the next highest priority, and private vehicles have the lowest priority. Alternatively, it is considered that each vehicle owner is charged some type of fee for using the server. In this case, the higher the amount of charge, the higher the priority. In yet another method, it is also possible to compare available resources between vehicles and give higher priority to vehicles with fewer resources. Furthermore, a method may also be adopted in which the longer time a vehicle is expected to travel within the area covered by the server, the higher priority the vehicle is given. It is also possible to adopt a method in which a score is calculated for each vehicle by combining the above methods in any manner, and a higher priority is given to vehicles with higher scores.

The program also includes step 804, following step 802, of repeating computation to allocate resources of the edge server to the real-time applications in order from a higher-priority switching type vehicle in accordance with the priority determined in step 802, as long as resources of the edge server are available, and allocating, in the process, resources of the edge server to the real-time applications of the relevant vehicle, and step 806, following step 804, of allocating resources of the relevant vehicle to real-time applications of the relevant vehicle to which resources of the edge server cannot be allocated, and terminating the processing.

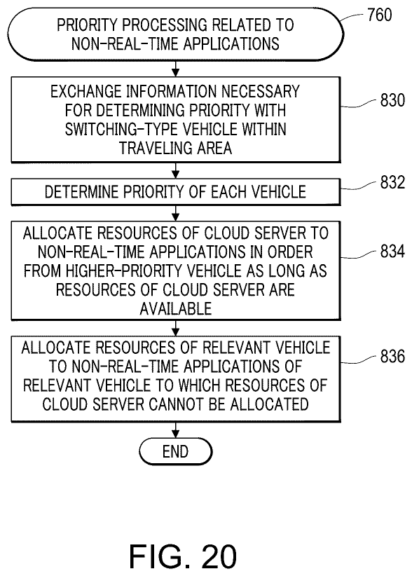

FIG. 20 shows the details of the priority processing related to the non-real-time applications that is executed in step 760 in FIG. 18. Referring to FIG. 20, step 760 includes step 830 in which the MPU 402 exchanges information for determining the priority with another switching-type vehicle within the traveling area and another switching-type vehicle predicted to enter the traveling area, and step 832 in which the MPU 402 determines the priority of each of the switching-type vehicles based on the information exchanged in step 830.

Step 760 also includes step 834 of allocating resources of the cloud server to the non-real-time applications in order from a higher-priority switching-type vehicle in accordance with the priority calculated in step 832, as long as the resources of the cloud server are available, and step 836, following step 834, of allocating resources of the relevant vehicle to non-real-time applications of the relevant vehicle to which resources of the cloud server cannot be allocated, and terminating step 760.

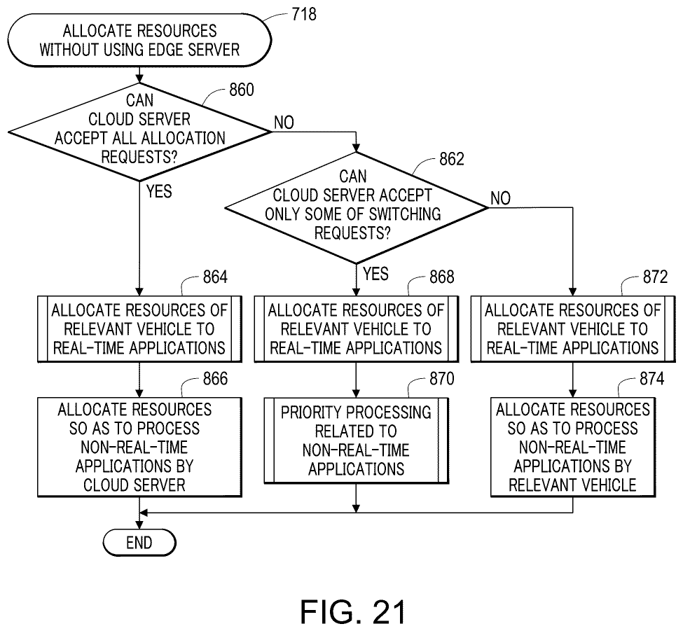

FIG. 21 shows the details of step 718 in FIG. 17. Referring to FIG. 21, step 718 includes step 860 of determining whether the cloud server can accept all of the allocation requests and branching the control flow in accordance with the determination result. If the determination result in step 860 is “Yes”, the MPU 402 allocates resources of the relevant vehicle to the real-time applications in step 864. Further, step 718 also includes step 866 in which the MPU 402 allocates resources of the cloud server to the non-real-time applications, and terminates step 718.

If the determination result in step 860 is “No”, in step 862, the MPU 402 further branches the control flow in accordance with whether the cloud server can accept only some of the allocation requests. If the determination result in step 862 is “Yes”, the control proceeds to step 868. In step 868, the MPU 402 allocates resources of the relevant vehicle to the real-time applications. Further, step 718 also includes step 870 in which the MPU 402 executes priority processing related to the non-real-time applications and terminates step 718. Step 870 is the same as step 760 shown in FIG. 20.

If the determination result in step 862 is “No”, in step 872, the MPU 402 allocates resources of the relevant vehicle to the real-time applications. In the following step 874, the MPU 402 allocates resources of the relevant vehicle to the non-real-time applications, and terminates step 718.

### 3. Operation

The in-vehicle edge server 80 of the above-described configuration (see FIG. 5) operates as follows. Referring to FIG. 8, at the time when the in-vehicle edge server 80 starts operation (the time when the processing in FIG. 8 starts), the initial allocation unit 452 of the vehicle 320 starts communicating with a server (e.g., the cloud server 304 shown in FIG. 3) that covers the area in which the vehicle 320 is present (step 510 in FIG. 8). Based on information obtained from the server, the initial allocation unit 452 performs resource allocation processing for the real-time applications and the non-real-time applications of the vehicle 320 (step 512). In accordance with the allocation result, the application control unit 458 reads out from the application storage unit 462 the applications to which resources of the cloud server or the edge server are allocated, and transmits the read applications to the cloud server or the edge server via the communication processing unit 450 to request execution. In this case, applications to which resources of the cloud server are allocated are non-real-time applications. Applications to which resources of the edge server may be either real-time applications or non-real-time applications. If no edge server is present, resources of the relevant vehicle are allocated to the real-time applications. The application control unit 458 reads out from the application storage unit 462 the applications to which resources of the relevant vehicle are allocated, and causes the application execution unit 460 to executes the read applications. Thereafter, the in-vehicle edge server 80 repeats, up to this point, processing of downloading information regarding nearby vehicles and information regarding driving assistance from the server covering each traveling area (step 514), and reallocating resources to each application based on this information communication (step 516).

Here, for example, it is assumed that the vehicle 320 is traveling within the traveling area 300, and it is predicted that the vehicle 320 will move to the adjacent area 302 after a certain time t1 according to its travel schedule, as shown in FIG. 3. The traveling area 300 is covered by the cloud server 304. The adjacent area 302 is covered jointly by the cloud server 306 and the edge server 308.

In the situation shown in FIG. 3, for example, the vehicle 324 in the traveling area 300 is of the independent type, and the vehicle 322 is of the switching type. The vehicle 324 is predicted to exit the traveling area 300 in the near future. The vehicle 322 is traveling behind the vehicle 320. Accordingly, it is predicted that the vehicle 322 will not exit the traveling area 300 for a while. Also, the vehicles 326 and 328 are present in the adjacent area 302. Among them, the vehicle 326 is traveling away from the traveling area 300. The edge server 308 and the cloud server 306 predict that the vehicle 328 will enter the traveling area 300 from the adjacent area 302 after a time t2 elapses from the current time. Here, it is assumed that t2 is longer than t1 (t2<t1). The edge server 308 also predicts that the vehicle 326 will remain in the adjacent area 302 even after the time t1.

Referring to FIG. 5, the change detection unit 454 of vehicle 320 predicts that the switching-type vehicle 328 will enter the traveling area 300 after the time t2 according to the travel schedule. In this case, the number of switching-type vehicles within the traveling area 300 increases from two to three. In response to detecting this change, the change detection unit 454 notifies the reallocation unit 456 of the increase in the number of switching-type vehicles. In response to the notification, the reallocation unit 456 executes resource reallocation processing for the real-time applications and the non-real-time applications of the vehicle 320. In accordance with the reallocation result, the application control unit 458 requests the cloud server 304 to execute the non-real-time applications to which resources of the cloud server 304 are allocated. As for the applications to which resources of the vehicle 320 are allocated, the application control unit 458 causes these resources to execute the applications.

Note that the vehicles 322, 328, and 326 shown in FIG. 3 also execute similar processing. Upon the vehicle 328 entering the traveling area 300 from the adjacent area 302, the number of switching-type vehicles within the traveling area of the vehicle 328 increases from two to three. Accordingly, the vehicles 322 and 328 execute processing similar to the above-described processing performed by the vehicle 320. For the vehicle 326, the number of switching-type vehicles within the traveling area decreases from two to one. Accordingly, resources are also reallocated in the vehicle 326. In this case, in general, the vehicle 326 allocates resources of the cloud server 306 and the edge server 308 to more applications, although it depends on what types of applications the vehicle 328 has allocated resources of the cloud server 306 and the edge server 308 to.

Further, assume that the vehicle 320 moves to the adjacent area 302 after the vehicle 328 has entered the traveling area 300. In this case, the traveling area of the vehicle 320 changes from the traveling area 300 to the adjacent area 302. The number of switching-type vehicles within the traveling area of the vehicle 320 changes from three to two. Accordingly, the vehicle 320 executes resource reallocation processing. This also applies to the vehicle 326, which executes resource reallocation processing in response to detecting that the number of switching-type vehicles in the adjacent area 302 has increased from one to two. In this process, the priority calculation is performed between the vehicles 326 and 320, and resources of the cloud server 306 and the edge server 308 are reallocated in both the vehicles 326 and 320 in accordance with the calculation results.

Meanwhile, as a result of the vehicle 320 moving to the adjacent area 302, the number of switching-type vehicles within the traveling area 300 decreases from three to two. Consequently, resource reallocation processing is also executed in the vehicles 322 and 328.

Note that available server resources do not change when an independent-type vehicle moves between areas. Accordingly, in this case, resource reallocation processing is not executed in switching-type vehicles. On the other hand, the situation is different when a cooperative-type vehicle moves between areas. If a vehicle entering a certain area is of the cooperative type, a fixed number of server resources is allocated to this cooperative-type vehicle. Conversely, if a vehicle exiting a certain area is of the cooperative type, a fixed number of server resources becomes available. Accordingly, in these cases, if a cooperative-type vehicle is present in the area, resource reallocation processing is executed in both cases.

As described above, according to this embodiment, server resources and resources of the relevant vehicle are reallocated to applications in a switching-type vehicle in accordance with a change in the numbers of cooperative-type vehicles and switching-type vehicles that are present in the traveling area. This demonstrates the effect of effectively using server resources and reducing the processing load on each vehicle by flexibly distributing server resources between applications of the vehicle, thus flexibly providing various functions.

### II. MODIFICATION

In the above embodiment, the switching-type vehicle obtains information such as vehicle movement status of nearby vehicles via the servers. However, the present disclosure is not limited to this mode. Alternatively, the switching-type vehicle may directly obtain information such as vehicle movement status of nearby vehicles by means of inter-vehicle communication with the other vehicles. However, in this case, the vehicle movement status of at least independent-type vehicles and vehicles that are not originally equipped with an in-vehicle edge server needs to be obtained via a server or calculated based on sensor data of the relevant vehicle. Alternatively, the switching-type vehicle may obtain information such as the vehicle movement status of the other vehicles by communicating with infrastructure facilities, such as roadside devices.

Each piece of processing (each function) of the above embodiment is realized by circuitry including one or more processors. The circuitry may be constituted by, for example, an integrated circuit combining the aforementioned one or more processors, as well as one or more memories, various analog circuits, and various digital circuits. The one or more memories store programs (instructions) that cause the one or more processors to execute each piece of the above processing. The one or more processors may execute each piece of the above processing in accordance with the programs retrieved from the one or more memories, or a logic circuit designed in advance to execute each piece of the above processing may execute the processing. Each of the processors may be any of various types of processors that are compatible with computer control, such as a central processing unit (CPU), a graphics processing unit (GPU), a digital signal processor (DSP), a field programmable gate array (FPGA), or an application specific integrated circuit (ASIC). Note that the plurality of physically separated processors may cooperate with each other to execute each piece of the above processing. For example, the processors installed in the respective, physically separated computers may cooperate with each other via a network such as a local area network (LAN), a wide area network (WAN), or the Internet to execute each piece of the above processing. The programs may be installed into the memories via the network from an external server device or the like, or may be distributed in a state stored on a recording medium such as a CD-ROM (Compact Disc Read-Only Memory), a DVD-ROM (Digital Versatile Disk Read-Only Memory), or a semiconductor memory, and installed into the memories from the recording medium.

Note that the embodiments disclosed herein are in all respects illustrative and should not be considered restrictive. The scope of the present disclosure is not defined by the detailed description of the disclosure but by the claims, and is intended to include all changes made within the meaning and scope equivalent to the language of the claims.

1. A resource allocation method that is capable of being used in an in-vehicle device that provides driving assistance functions by communicating with a server,
the in-vehicle device being a switching in-vehicle device that allocates resources to each function of the in-vehicle device while switching between resources of a service providing device covering a traveling area of a vehicle equipped with the in-vehicle device and resources of a relevant vehicle being the vehicle equipped with the in-vehicle device,
the resource allocation method comprising:
executing allocation processing to allocate, to each function of the in-vehicle device, resources of the server being the service providing device covering the traveling area of the relevant vehicle and resources of the relevant vehicle, with use of a processor; and
re-executing the allocation processing in response to detecting or predicting a change in a number of vehicles that are present within the traveling area and that cooperate with the server, with use of the processor.

2. The method according to claim 1,
wherein the re-executing includes:
judging whether each vehicle present within a nearby area including the traveling area and an adjacent area being an area adjacent to the traveling area is an independent vehicle that does not cooperate with the service providing device, a cooperative vehicle that cooperates with the service providing device using fixed resource allocation, or a switching vehicle equipped with the switching in-vehicle device, with use of the processor;
determining whether or not a vehicle other than the independent vehicle is present within the nearby area, with use of the processor; and
executing processing to reallocate, to each function of the in-vehicle device, resources of the relevant vehicle and resources of the server in accordance with available resources of the server, in response to determining that a vehicle other than the independent vehicle is present within the nearby area, with use of the processor.

3. The method according to claim 2,
wherein the executing processing to reallocate resources includes:
determining whether or not the switching vehicle other than the relevant vehicle is present within the nearby area, with use of the processor;
executing processing to reallocate, to each function of the in-vehicle device, resources of the server and resources of the relevant vehicle based on a result of coordination regarding resources of the server with the switching vehicle present within the nearby area and a status of available resources of the server, in response to a result of the determination indicating that the switching vehicle other than the relevant vehicle is present within the nearby area, with use of the processor; and
executing processing to reallocate, to each function of the in-vehicle device, resources of the server and resources of the relevant vehicle based on the status of available resources of the server, in response to the result of the determination indicating that the switching vehicle other than the relevant vehicle is not present within the nearby area, with use of the processor.

4. The method according to claim 3,
wherein the executing processing to reallocate in response to the result of the determination indicating that the switching vehicle other than the relevant vehicle is present within the nearby area includes:
detecting or predicting an increase in the number of cooperative vehicles or the number of switching vehicles present within the traveling area, in response to the result of the determination indicating that the switching vehicle other than the relevant vehicle is present within the nearby area, with use of the processor;
determining whether or not resources of the server are to become insufficient, in response to detecting or predicting an increase in the number of cooperative vehicles or the number of switching vehicles present within the traveling area, with use of the processor; and
in response to a result of the determination indicating that resources of the server are to become insufficient, executing coordination regarding resources of the server with the switching vehicle present within the nearby area, and switching at least some of the resources of the server that have been allocated to functions of the in-vehicle device to resources of the relevant vehicle based on a result of the coordination, with use of the processor.

5. The method according to claim 4,
wherein the executing processing to reallocate in response to the result of the determination indicating that the switching vehicle other than the relevant vehicle is present within the nearby area further includes:
detecting or predicting a decrease in the number of cooperative vehicles or the number of switching vehicles present within the traveling area, in response to the result of the determination indicating that the switching vehicle other than the relevant vehicle is present within the nearby area, with use of the processor;
determining whether or not more resources of the server are to become available, in response to detecting or predicting a decrease in the number of cooperative vehicles or the number of switching vehicles present within the traveling area, with use of the processor; and
in response to a result of the determination indicating that more resources of the server are to become available, executing coordination regarding resources of the server with the switching vehicle present in the nearby area, and switching at least some of the resources of the relevant vehicle that have been allocated to functions of the in-vehicle device to resources of the server based on a result of the coordination, with use of the processor.

6. The method according to claim 3,
wherein the executing processing to reallocate in response to the result of the determination indicating that the switching vehicle other than the relevant vehicle is present within the nearby area includes:
detecting or predicting a decrease in the number of cooperative vehicles or the number of switching vehicles present within the traveling area, in response to the result of the determination indicating that the switching vehicle other than the relevant vehicle is present within the nearby area, with use of the processor;
determining whether or not more resources of the server are to become available, in response to detecting or predicting a decrease in the number of cooperative vehicles or the number of switching vehicles present within the traveling area, with use of the processor; and
in response to a result of the determination indicating that more resources of the server are to become available, switching at least some of the resources of the relevant vehicle that have been allocated to functions of the in-vehicle device to resources of the server, with use of the processor.

7. The method according to claim 3,
wherein the executing processing to reallocate in response to the result of the determination indicating that the switching vehicle other than the relevant vehicle is not present within the nearby area includes:
detecting or predicting an increase in the number of cooperative vehicles present within the traveling area, in response to the result of the determination indicating that the switching vehicle other than the relevant vehicle is not present within the nearby area, with use of the processor;
determining whether or not resources of the server are to become insufficient, in response to detecting or predicting an increase in the number of cooperative vehicles present within the traveling area, with use of the processor; and
in response to a result of the determination indicating that resources of the server are to become insufficient, switching at least some of the resources of the server that have been allocated to functions of the in-vehicle device to resources of the relevant vehicle, with use of the processor.

8. The method according to claim 7,
wherein the executing processing to reallocate in response to the result of the determination indicating that the switching vehicle other than the relevant vehicle is not present within the nearby area further includes:
detecting or predicting a decrease in the number of cooperative vehicles present within the traveling area, in response to the result of the determination indicating that resources of the server are to become insufficient, with use of the processor;
determining whether or not more resources of the server are to become available, in response to detecting or predicting a decrease in the number of cooperative vehicles present within the traveling area, with use of the processor; and
in response to a result of the determination indicating that more resources of the server are to become available, switching at least some of the resources of the relevant vehicle that have been allocated to functions of the in-vehicle device to resources of the server, with use of the processor;

9. The method according to claim 3,
wherein the executing processing to reallocate in response to the result of the determination indicating that the switching vehicle other than the relevant vehicle is not present within the nearby area includes:
detecting or predicting a decrease in the number of cooperative vehicles present within the traveling area, in response to the result of the determination indicating that the switching vehicle other than the relevant vehicle is not present within the nearby area, with use of the processor;
determining whether or not more resources of the server are to become available, in response to detecting or predicting a decrease in the number of cooperative vehicles present within the traveling area, with use of the processor; and
in response to a result of the determination indicating that more resources of the server are to become available, switching at least some of the resources of the relevant vehicle that have been allocated to functions of the in-vehicle device to resources of the server, with use of the processor;

10. The method according to claim 5, wherein:
the server of the traveling area includes at least a first server,
the functions of the in-vehicle device include first functions and second functions that require faster response than the first functions, and
the switching to resources of the server includes:
determining whether or not the server of the traveling area further includes a second server whose response is faster than the first server; and
allocating resources of the relevant vehicle to the second functions and allocating resources of the first server to the first functions in response to determining that the server does not include the second server.

11. The method according to claim 10, wherein:
the switching to resources of the server further includes:
allocating resources of the first server to the first functions and allocating resources of the second server to the second functions in response to determining that the server includes the second server.

12. The method according to claim 5, wherein:
the server of the traveling area includes at least a first server,
the functions of the in-vehicle device include first functions and second functions that require faster response than the first functions, and
the switching to resources of the server includes:
determining whether or not the server of the traveling area further includes a second server whose response is slower than the first server; and
allocating resources of the first server to the first functions and the second functions in response to determining that the server does not include the second server.

13. The method according to claim 12, wherein:
the switching to resources of the server further includes:
allocating resources of the second server to the first functions and allocating resources of the first server to the second functions, in response to determining that the server includes the second server.

14. The method according to claim 5, wherein:
the server of the traveling area includes a first server and a second server whose response is faster than the first server,
the functions of the in-vehicle device include first functions and second functions that require faster response than the first functions, and
the switching to resources of the server includes:
allocating, to the second functions, as many resources of the second server as the second server allows;
allocating, to the first functions, as many resources of the first server and resources of the second server as the first server and the second server allow; and
allocating resources of the relevant vehicle to a function that is included in the second functions and to which resources of the second server are not allocatable, and to a function that is included in the first functions and to which neither resources of the first server nor resources of the second server are allocatable.

15. The method according to claim 14, wherein:
the allocating, to the second functions, as many resources of the second server as the second server allows includes:
determining whether or not resources of the second server are allocatable to all of the second functions;
allocating resources of the second server to all of the second functions in response to determining that resources of the second server are allocatable to all of the second functions;
in response to determining that resources of the second server are not allocatable to at least some of the second functions, executing coordination regarding allocation of resources of the second server with another switching present within the traveling area, and allocating as many resources of the second server as possible to the at least some of the second functions in accordance with a result of the coordination; and
allocating resources of the relevant vehicle to a function that is included in the second functions and to which resources of the second server are not allocatable based on the result of the coordination.

16. The method according to claim 14, wherein:
the allocating, to the first functions, as many resources of the first server and resources of the second server as the first server and the second server allow includes:
determining whether or not resources of the first server are allocatable to all of the first functions;
allocating resources of the first server to all of the first functions in response to determining that resources of the first server are allocatable to all of the first functions;
in response to determining that resources of the first server are not allocatable to at least some of the first functions, executing coordination regarding allocation of resources of the first server with another cooperative vehicle and another switching vehicle that are present within the traveling area, and allocating as many resources of the first server as possible to the at least some of the first functions in accordance with a result of the coordination; and
allocating resources of the relevant vehicle to a function that is included in the first functions and to which resources of the first server are not allocatable based on the result of the coordination.

17. A resource allocation apparatus that is configured to be used in an in-vehicle device that provides driving assistance functions by communicating with a server,
the in-vehicle device being a switching in-vehicle device that allocates resources to each function of the in-vehicle device while switching between resources of a server covering a traveling area of a vehicle equipped with the in-vehicle device and resources of a relevant vehicle being the vehicle equipped with the in-vehicle device,
the resource allocation apparatus comprising:
a processor that is configured to:
execute allocation processing to allocate, to each function of the in-vehicle device, resources of the server covering the traveling area of the relevant vehicle and resources of the relevant vehicle; and
re-execute the allocation processing in response to detecting or predicting a change in the number of vehicles that are present in the traveling area and that cooperate with the server.

18. A storage medium that stores a computer program that causes a processor to allocate resources in an in-vehicle device that provides driving assistance functions by communicating with a server,
the in-vehicle device being a switching in-vehicle device that allocates resources to each function of the in-vehicle device while switching between resources of a server covering a traveling area of a vehicle equipped with the in-vehicle device and resources of a relevant vehicle being the vehicle equipped with the in-vehicle device,
the computer program causing the processor to:
execute allocation processing to allocate, to each function of the in-vehicle device, resources of the server covering the traveling area of the relevant vehicle and resources of the relevant vehicle; and
re-execute the allocation processing in response to detecting or predicting a change in the number of vehicles that are present in the traveling area and that cooperate with the server.
